(19) United States
(12) Patent Application Publication
(10) Pub. No.: US 2010/0006394 A1
(43) Pub. Date: Jan. 14, 2010

(54) Transitions between conveyance paths

(76) Inventors: Barry Kitazumi, Fremont, CA (US); Tac V. Huynh, Fremont, CA (US); Torrence Virgil Harrison, Hayward, CA (US); Geng-Peng Liu, Taichung (TW)

Correspondence Address: CARR & FERRELL LLP, 2200 GENG ROAD, PALO ALTO, CA, 94303, US

(21) Appl. No.: 12/218,405

(22) Filed: Jul. 14, 2008

(51) Int. Cl. B65G 47/14; B65G 47/31; G06F 7/00

(52) U.S. Cl. 198/370.03; 198/461.1; 700/230

(57) ABSTRACT

Various exemplary systems and methods provide for the smooth conveyance of an article and transfer of an article on or off a conveyance path. In one example, a system comprises a first conveyance path having two ends, in which the conveyance path includes a plurality of conveyance rollers arranged to convey the article from the first end to the second end, and at least one of the rollers is configured to rotate at a first rate to drive the article. The system further comprises a transition mechanism disposed proximate to the second end of the first conveyance path. The transition mechanism includes a transition wheel positioned to receive the article from the second end, and the transition wheel is configured to be driven at a second rate that is coordinated with the first rate.

### CROSS-REFERENCE TO RELATED APPLICATION

The present application is related to U.S. Pat. No. 7,281,623, filed Apr. 18, 2006, and entitled “Transport System Including Vertical Rollers,” which is incorporated by reference herein.

### BACKGROUND

1. Technical Field

The present invention relates generally to conveying articles in a manufacturing or transportation facility.

2. Description of Related Art

The automated transport of articles in a manufacturing facility can be facilitated by the use of belts on rollers. For example, semiconductor fabrication facilities currently use automated transport systems to move semiconductor wafers during the manufacturing process. Typically, a batch of wafers may be conveyed together in a container known as a Front Opening Unified Pod (FOUP).

FIG. 1 shows an isometric view of a pair of belts 102 used to transport an article 104 in the prior art. The belts 102 carry the article 104. The belts 102 are supported by rollers 112.

FIG. 1 also depicts guidance directional vectors corresponding to a vertical direction 106, a conveyance direction 108, and a horizontal direction 110. With regard to FIG. 1, the article 104 is conveyed along the conveyance direction 108. The vertical direction 106 is orthogonal to the conveyance direction 108. The horizontal direction 110 is orthogonal to both the vertical direction 106 and the conveyance direction 108. The directions 106, 108, and 110 are also depicted in FIGS. 2-8 to define viewpoints.

The belts 102 have a point at which the articles 104 to be transported are loaded and/or unloaded. Typically, these load and unload points are at the ends of the belts 102. Unfortunately, when loading and unloading the articles 104 that move at high speeds, the articles 104 (e.g., FOUPs) may be jarred or jostled, which may create damage.

FIG. 2A shows an interface between two pairs of belts 204a and 204b in the prior art. FIG. 2A highlights how this interface may create abrupt, jarring, slowing, or otherwise detrimental responses in an article (e.g., the article 104) moving from the belts 204a to the belts 204b. Each pair of belts 204a and 204b is supported by a series of rollers 210 to convey the article. The belts 204a and 204b meet at a junction 206, which is characterized by a discontinuity 202 in the support of the article being conveyed. The transport of the article being conveyed over the discontinuity 202 from the belts 204a to the belts 204b can cause damage to the article or the contents of the article (e.g., semiconductor wafers within a FOUP). Further, the article may be jostled out of alignment requiring correction.

FIG. 2B shows an interface between two series of rollers 208a and 208b in the prior art. FIG. 2B highlights how this interface may create abrupt, jarring, slowing, or otherwise detrimental responses in an article (e.g., the article 104) moving from the rollers 208a to the rollers 208b. Each series of rollers 208a and 208b conveys the article without a belt; the article is conveyed by the rollers themselves. Each series of rollers 208a and 208b meet at one end at the junction 206, which is characterized by the discontinuity 202. For fragile articles or other articles susceptible to problems due to such discontinuities 202, these junctions 206 can be problematic.

For an article that is susceptible to damage from fast acceleration or deceleration, it may be necessary to gently accelerate the article to the velocity of the belts 204 or rollers 208 prior to loading, and it may also be necessary to gently decelerate the article after removal from the belts 204 or rollers 208. Accelerating and decelerating the article, however, requires careful control and increases the time of transport.

### SUMMARY OF THE INVENTION

Exemplary embodiments provide for a system for conveying an article. Various systems comprise a first conveyance path having two ends, in which the conveyance path includes a plurality of conveyance rollers arranged to convey the article from the first end to the second end, and at least one of the rollers is configured to rotate at a first rate to drive the article. The system may further comprise a transition mechanism disposed proximate to the second end of the first conveyance path. The transition mechanism may include a transition wheel positioned to receive the article from the second end, and the transition wheel may be configured to be driven at a second rate that is coordinated with the first rate.

In certain embodiments, the transition wheel is driven by a clutch, and in some cases, this clutch transfers power from the first conveyance path. In select embodiments, this clutch includes a non-contact magnetic coupling.

Various embodiments provide for conveyance paths and/or transition mechanisms that include a belt disposed around at least two rollers. The belt is driven, and is configured to transfer the weight of the article being transported to the rollers. In some embodiments, a plurality of protrusions can extend from a belt, and these protrusions can support the article being transported, transferring the weight of the article to the belt.

Other embodiments provide for multiple conveyance paths, connected by one or more transition mechanisms. In certain embodiments, transition mechanisms can be adjusted in various directions and/or angles to adjust the transport path of an article, and in some cases, these adjustments can be used to guide an article to various different conveyance paths.

Certain embodiments combine a transition mechanism with a conveyance path, and in some cases, this combination moves in a coordinated fashion. For some combinations, this motion can include rotation about an axis, providing for the rotation of the combined conveyance path and transition mechanism. Various embodiments include an air bearing disposed with a transition mechanism and/or a conveyance path, which may help support the weight of some articles.

Further embodiments provide for a method of transferring an article to or from a conveyance path having a first end, a second end, and a plurality of conveyance rollers arranged to convey the article from the first end to the second end. At least one of the rollers is configured to rotate at a first rate to drive the article. The method comprises receiving an article from the second end of the first conveyance path, supporting the article using a wheel rotating at a second rate that is coordinated with the first rate, and, providing the article to a second conveyance path.

### BRIEF DESCRIPTION OF THE DRAWINGS

FIG. 1 shows an isometric view of a pair of belts used to transport an article in the prior art.

FIG. 2A shows an interface between two pairs of belts in the prior art.

FIG. 2B shows an interface between two series of rollers in the prior art.

FIG. 3 shows a transition mechanism operable to facilitate the transition of an article from a conveyance path to another conveyance path, in an exemplary embodiment.

FIG. 4 shows an exemplary transition mechanism having multiple linkages.

FIG. 5 is an overhead view of conveyance paths, in an exemplary embodiment.

FIG. 6 shows a transition mechanism that provides for additional adjustability in the transition direction, according to an exemplary embodiment.

FIG. 7 is a view of several conveyance paths, according to an exemplary embodiment.

FIG. 8 shows an exemplary embodiment that incorporates an air bearing between a pair of transition mechanisms.

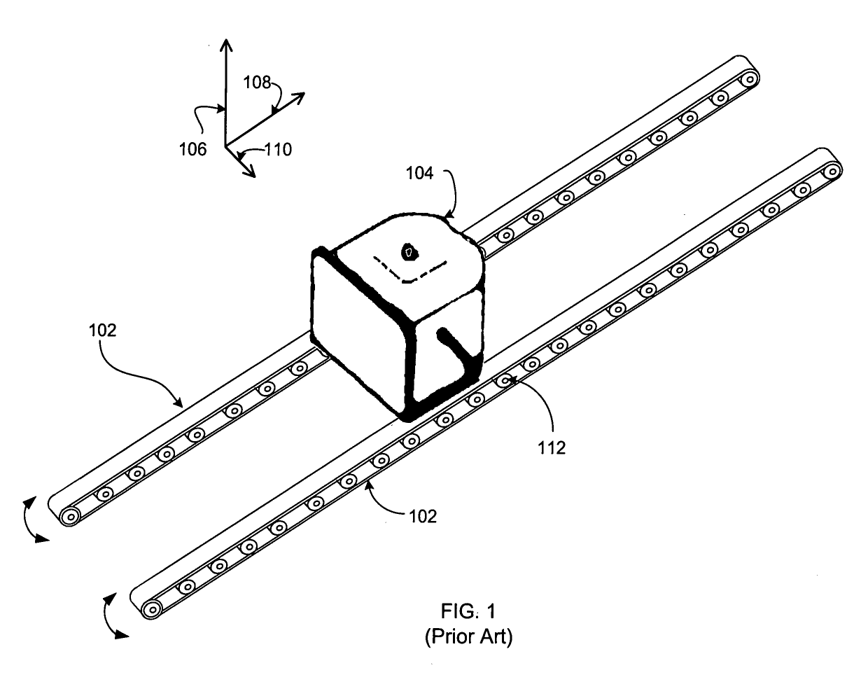

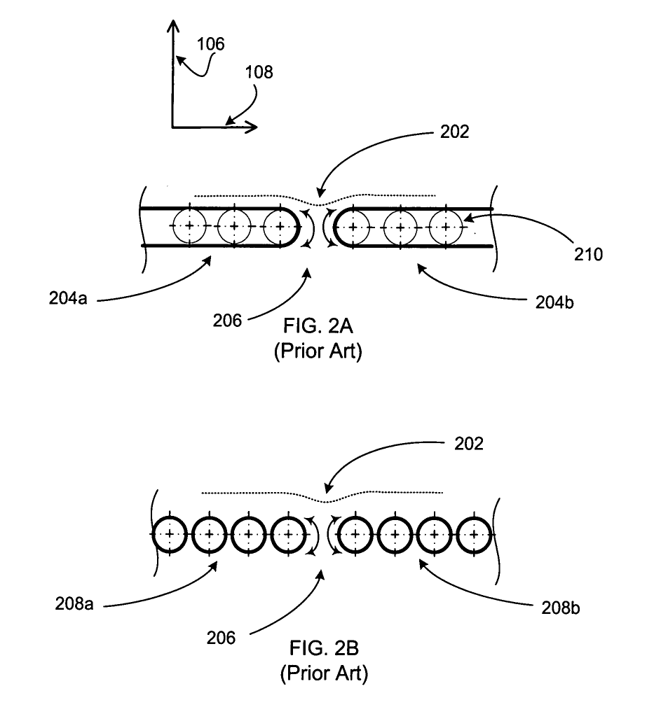

### DETAILED DESCRIPTION OF THE INVENTION

Various embodiments facilitate the smooth transfer of articles to and from conveyance paths. For example, for belts that transport an article at a high speed, it may be advantageous to match the trajectory and speed of the article being transported to that of a motive section of the belts that the article is being loaded onto or removed from. For example, it may be useful to match the velocity of the article being transported to the velocity of the belts during loading or unloading.

The conveyance paths may include rollers, belts, sliders, or other apparatuses which move the article(s) from one end of the conveyance path to the other. Conveyance paths may include a straight, curvilinear, horizontal, inclined, or declined section.

Embodiments may be practiced within a manufacturing environment, a transportation environment, a logistics environment, or any other facility in which high throughput transfer of articles is required. These environments may include semiconductor fabrication facilities, flat panel display fabrication facilities, photovoltaic panel (e.g., solar panel) fabrication facilities, drywall fabrication facilities, flooring fabrication facilities, shipping centers, and other facilities, for example.

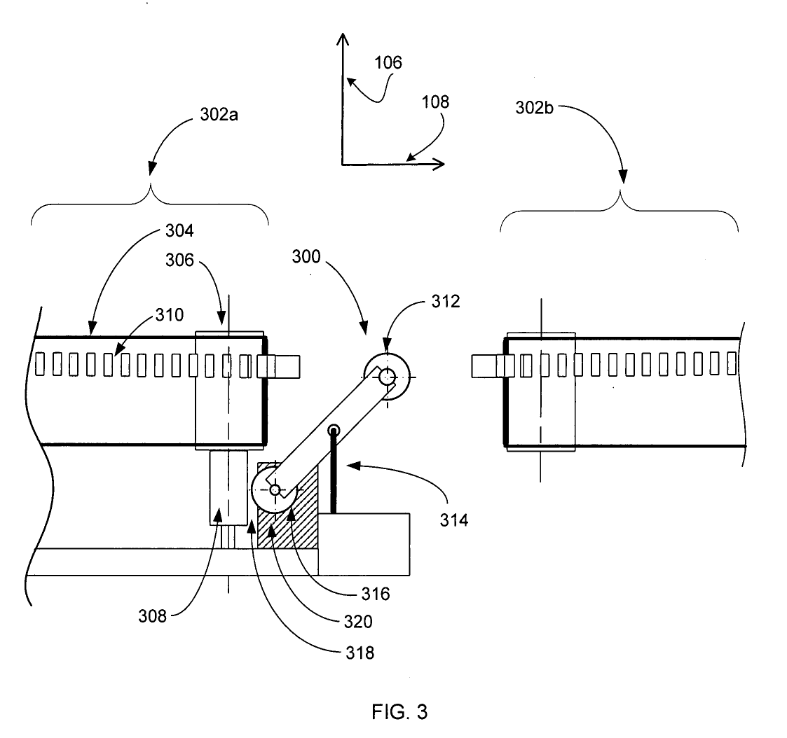

FIG. 3 shows a transition mechanism 300 operable to facilitate the transition of an article (e.g., the article 104) from a conveyance path 302a to a conveyance path 302b, in an exemplary embodiment. The conveyance path 302a comprises a vertical belt 304 disposed around a vertically oriented roller 306. The belt 304 includes a series of protrusions 310 extending horizontally from the belt 304. The protrusions 310 may support the weight of the article being transported. Although FIG. 3 depicts one belt 304 and one roller 306 of the conveyance path 302a, those skilled in the art will appreciate that there may be two or more belts 304, each with a series of protrusions 310. Further, there may be any number of rollers 306 that comprise the conveyance path 302a and any number of other rollers that comprise the conveyance path 302b. U.S. Pat. No. 7,281,623, filed Apr. 18, 2006, and entitled “Transport System Including Vertical Rollers,” which is incorporated by reference herein, provides examples of such conveyance paths.

The transition mechanism 300 includes a transition wheel 312. The transition wheel 312 may be driven by a drive wheel 316. The drive wheel 316 may be driven by a drive 320. The transition wheel 312 may provide support for the article being transferred. In various embodiments, the transition wheel 312 may provide rigid support, or may provide for deformation or displacement upon loading the article. The transition wheel 312 may include hard, soft, smooth, rough, low friction, or high friction materials as desired.

In some embodiments, the transition wheel 312 may not be powered or driven by the transition mechanism 300. In these embodiments, the transition wheel 312 may be stationary until contacted by the article for which the transition wheel 312 provides support. Due to the momentum of the article being conveyed, the article may cause the transition wheel 312 to rotate with an angular velocity corresponding to the linear velocity of the article. Because the linear velocity of the article corresponds to an angular velocity of the roller 306 (i.e., first rate), the transition wheel 312 may be frictionally driven by the article to rotate at an angular velocity (i.e., second rate) which is coordinated with the angular velocity of the roller 306. In some embodiments, the transition wheel 312 may be configured to rotate freely with minimal friction and thereby not substantially retard the motion of the article. In other embodiments, the transition wheel 312 may be configured to reduce the linear velocity of the article which the transition wheel 312 supports. In embodiments where the transition wheel 312 is driven by the transition mechanism 300, the transition wheel 312 may be configured to increase the linear velocity of the article which the transition wheel 312 supports.

The transition mechanism 300 is supported by a linkage 314. The linkage 314 can be used to position and support the transition wheel 312 and support the article being transferred. The linkage 314 may comprise a rigid member that supports both the transition wheel 312 and the drive wheel 316 as well as a supporting member that supports the rigid member. In some embodiments, the linkage 314 can be used to position the transition wheel 312, and may also provide for an elastic response or shock absorbing (e.g., damped) response by the transition wheel 312 as desired. For example, the transition wheel 312 may be disposed at substantially the same level (with respect to vertical direction 106) as the level of the protrusions 310, such that the article carried by protrusions 310 passes smoothly onto the transition wheel 312. The transition wheel 312 may also be positioned at a slightly different level than the level of the protrusions 310, providing for a change in direction of the article being transferred.

For applications in which the transfer of the article between conveyance paths 302a and 302b should proceed without substantial acceleration or deceleration, it may be advantageous to drive the transition wheel 312 at an angular velocity (i.e., a first rate) that yields the same linear velocity (of the article being transferred) as the velocity (i.e., a second rate) of a component (e.g., the belt 304, a surface of the roller 306, or the protrusion 310) which conveys the article. Thus, the speed of the article may remain constant as the article is transferred from one conveyance path (e.g., the conveyance path 302a) to the next (e.g., the conveyance path 302b).

The transition mechanism 300 may include the drive 320 that may drive the drive wheel 316. The drive wheel 316 may drive the transition wheel 312. Those skilled in the art will appreciate that the drive wheel 316 may drive the transition wheel 312 in many ways including, but not limited to, using a belt that turns the transition wheel 312 in response to turning of the drive wheel 316. In various embodiments, the drive wheel 316 is optional. For example, the drive 320 may drive the transition wheel 312 without involving the drive wheel 316.

The drive 320 may include a motor, a clutch, or other motive device. In various embodiments, a drive source for the transition mechanism 300 includes an extension 308 to the roller 306. In one example, the extension 308 may rotate at the same angular velocity as the roller 306. The extension 308 and the drive 320 may be coupled by a magnetic coupling 318, which, for example, may be created by magnets contained within the extension 308 and the drive 320 or the drive wheel 316. This magnetic coupling may provide for the transfer of rotational energy between the extension 308 and the transition wheel 312. Thus, the transition wheel 312 may rotate at the same rate as roller 306, and may operate to move the article in the conveyance direction. Appropriate choice of wheel diameters, roller diameters, and/or gearing may be used to provide for an embodiment of the transition wheel 312 whose angular velocity corresponds to the same linear velocity (i.e., tangential velocity) as the belt 304. For example, the angular velocity of the transition wheel 312 may be such that the linear velocity of the article while supported by the transition wheel 312 may be the same as the linear velocity of the article while supported by the protrusions 310. The transition wheel 312 may also be configured to have a different velocity or an adjustable velocity, such that the article is accelerated or decelerated as the article moves from the conveyance path 302a to the transition mechanism 300.

While the transition mechanism 300 may provide some modification to the trajectory of the article being transferred, it may be advantageous to provide for loading and offloading of the article from one conveyance path (e.g., conveyance path 302a) to a choice of alternate conveyance paths (e.g., multiple embodiments of conveyance path 302b) at different angles and/or elevations with respect to each other and the conveyance path 302a. In some embodiments, the transition mechanism 300 is substantially attached to the conveyance path 302a, such that these components (i.e., the transition mechanism 300 and the conveyance path 302b) may move together.

Although FIG. 3 depicts the transition mechanism 300 including the transition wheel 312, the function of supporting the article may be performed by any mechanism, including, but not limited to, a variety of bearings, including ball bearings, journal bearings, magnetic bearings, one or more rollers, one or more wheels, or any combination of these. Similarly, although FIG. 3 depicts the roller 306, the function of the roller 306 may be performed by many components including, but not limited to, a variety of bearings, including ball bearings, journal bearings, magnetic bearings, one or more rollers, one or more wheels, or any combination of these.

Although FIG. 3 depicts the belt 304 as a part of the conveyance path 302a, the belt 304 is optional. In one example, the roller 306 and/or one or more of the protrusions 310 coupled to the roller 306 support the article without the belt 304. It will be appreciated by those skilled in the art that, in some embodiments, the article that is transported from the conveyance path 302a to the conveyance path 302b over the transition mechanism 300 may also be transported from the conveyance path 302b to the conveyance path 302a over the same transition mechanism 300 and achieve some or all of the same advantages.

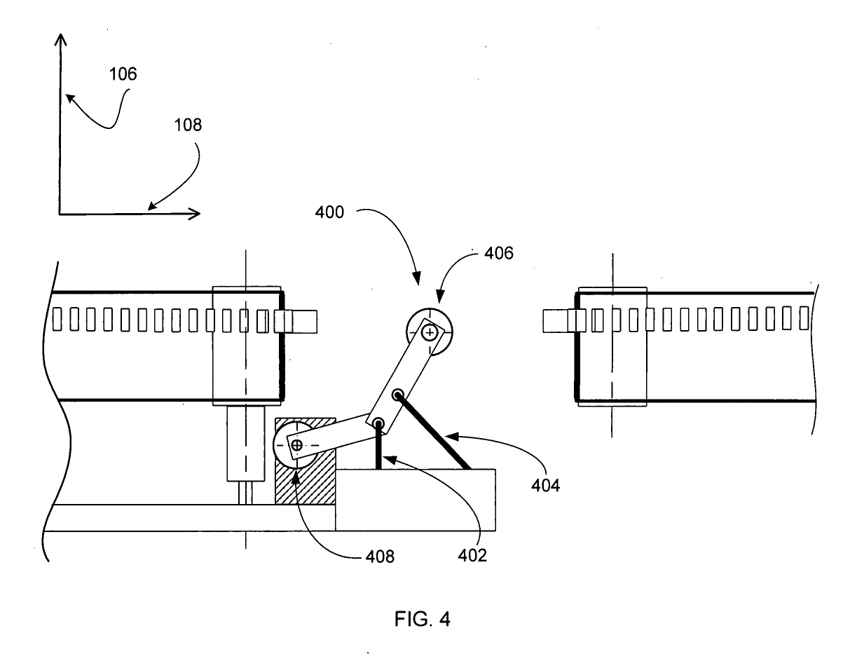

FIG. 4 shows an exemplary transition mechanism 400 having multiple linkages. Linkage 402 and linkage 404 may be operated to provide for adjustability of a transition wheel 406. Each of the linkages 402 and 404 may comprise a rigid member and a support member. The rigid member of linkage 402 may support a drive wheel 408 which drives the transition wheel 406. The rigid member of the linkage 404 may support the transition wheel 406. The linkage 402 and/or the linkage 404 may also provide for an elastic response or shock absorbing (e.g., damped) response by the transition wheel 406.

In various embodiments, the transition wheel 406 may be moved in any of directions 106, 108, and 110. The transition wheel 406 may also be rotated angularly about an axis (e.g., direction 108). Those skilled in the art will appreciate that transition mechanisms can be configured to provide for any desired modification in the trajectory of the article being conveyed. Although two linkages 402 and 404 are depicted in FIG. 4, there may be any number of linkages.

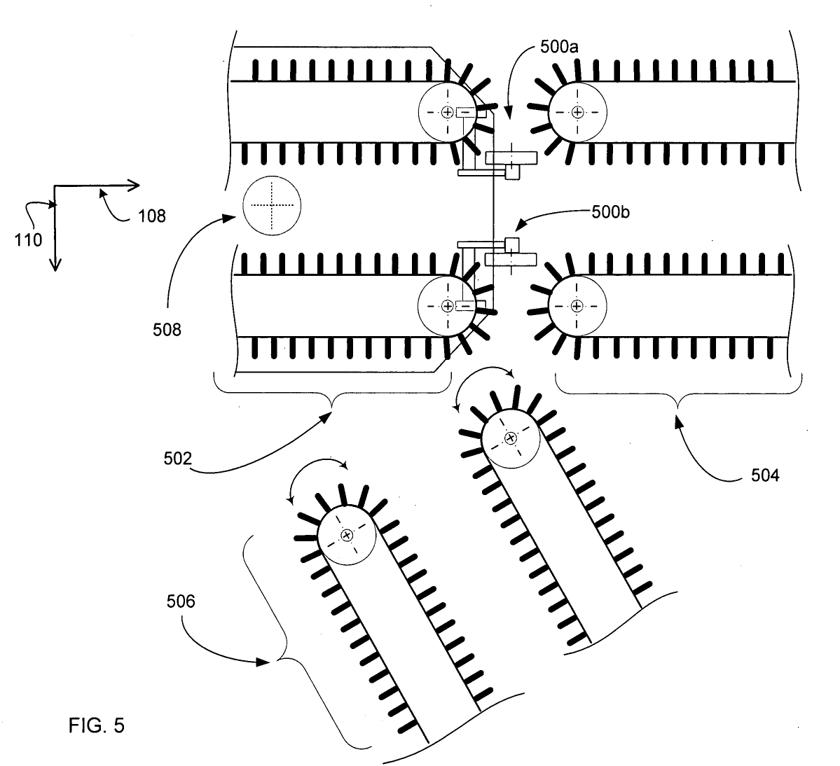

FIG. 5 is an overhead view of conveyance paths 502, 504, and 506, in an exemplary embodiment. The conveyance path 502 includes a pair of transition mechanisms 500a and 500b. The conveyance path 502 also includes a rotation mechanism 508, disposed between the end of conveyance path 502 shown in FIG. 5 and the opposite end (not shown). The rotation mechanism 508 can operate to rotate the combination of conveyance path 502 and transition mechanisms 500a and 500b between alignment with alternate conveyance paths 504 and 506. In one example, an article (e.g., the article 104) may be transferred from the conveyance path 502 to either the conveyance path 504 or the conveyance path 506. Those skilled in the art will appreciate that there are many mechanisms that may redirect the conveyance path 502.

The article may be loaded on conveyance path 502. In some embodiments, the conveyance path 502 may then be rotated to align with either of the conveyance paths 504 and 506 while the article is in motion. In one example, the article is slowed or stopped by the conveyance path 502 before and/or during the rotation of the conveyance path 502. In other embodiments, the conveyance path 502 is rotated before the article is loaded. Alternately, the conveyance path 502 may be rotated while the article is in motion, while the article is loaded onto the conveyance path 502, or while the article is unloaded from the conveyance path 502.

This combination of conveyance paths 502, 504, 506, transition mechanisms 500a and 500b, and the rotation mechanism 508 can be used to transfer the article between conveyance paths 504 and 506, notwithstanding a relatively acute angle describing the relationship between their respective conveyance directions. Different combinations of transition mechanisms and any number of conveyance paths may be used to configure various diverse trajectories for the transport of the article.

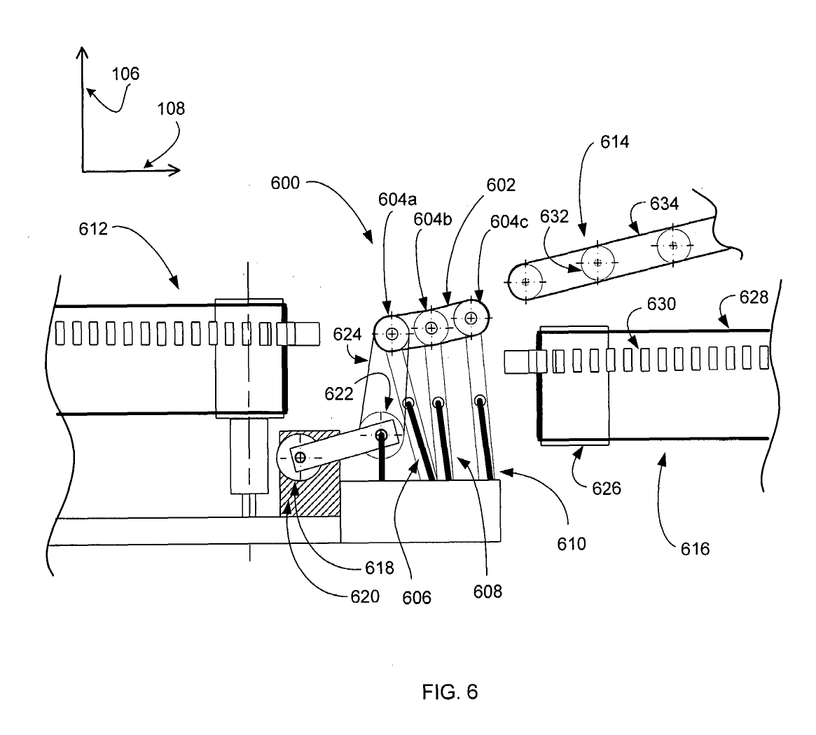

FIG. 6 shows a transition mechanism 600 that provides for additional adjustability in the transition direction, according to an exemplary embodiment. The transition mechanism 600 comprises a belt 602 about three transition wheels 604a, 604b, and 604c. In some embodiments, at least one of the transition wheels 604 is driven by a drive wheel 618 and/or a drive 620. In one example, the drive 620 drives the drive wheel 618. The drive wheel 618 may drive the transition wheel 604a directly or indirectly through additional wheels (e.g., a wheel 622) and/or belts (e.g., a belt 624). The transition wheel 604a, in turn, then drives the belt 602. Linkages 606, 608, and 610 may provide for the adjustability of each transition wheel 604, and can be used to modify the direction of an article (e.g., the article 104) moving from a conveyance path 612.

In one example, two additional conveyance paths 614 and 616 are provided near the conveyance path 612. The conveyance path 616 includes vertical rollers 626 and a vertical belt 628 with protrusions 630. The conveyance path 614 includes horizontal rollers 632 and a horizontal belt 634. The vertical distance between the conveyance paths 616 and 614 is sufficient to allow passage of the article being transported. Thus, the transition mechanism 600 may be configured to change an elevation of the article being transported. For example, the transition mechanism 600 may be raised to direct the article from the conveyance path 612 to the conveyance path 614, or may be lowered to direct the article to the conveyance path 616. As this example suggests, transition mechanisms can be used with a broad variety of conveyance paths, and can smoothly transfer the article between conveyance paths despite the sections corresponding to the conveyance paths not being aligned. Those skilled in the art will appreciate that there may be any number of wheels 604 as well as any number of linkages (e.g., linkages 606, 608, and 610). Further, one linkage may support one or more wheels 604.

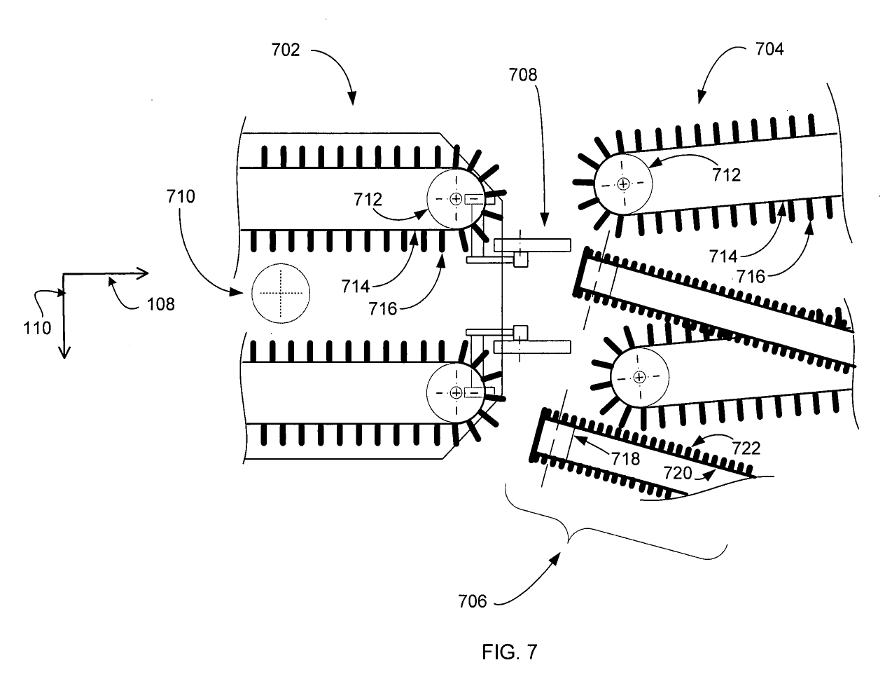

FIG. 7 is a view of several conveyance paths 702, 704, and 706, according to an exemplary embodiment. FIG. 7 illustrates one example of how transition mechanisms (e.g., transition mechanisms 708) can be used to transfer an article (e.g., the article 104) between closely packed conveyance paths (e.g., the conveyance paths 704 and 706). In many manufacturing facilities, optimization of space is an important aspect of cost and/or efficiency.

A pair of transition mechanisms 708 may be coupled to the conveyance path 702. The conveyance paths 702 and 704 may include vertical rollers 712 and belts 714, with horizontal protrusions 716 from the belts 714 disposed to carry the article. The conveyance path 706 may include horizontal rollers 718 and a belt 720 which has protrusions 722 disposed horizontally to carry the article. In one example, a portion of the conveyance path 706 passes over the conveyance path 704. Additionally, the relative directions of conveyance (at the ends shown) of the three conveyance paths 702, 704, and 706 may be disposed at different angles.

In various embodiments, a rotation mechanism 710 rotates, or otherwise alters the direction of the conveyance path 702. In one example, the rotation mechanism 710 may direct the conveyance path 702 such that the article may be directed to the conveyance path 704 or the conveyance path 706.

The combination of the transition mechanisms 708 and the rotation mechanism 710 can be used to adjust the horizontal, vertical, and angular direction of the article as the article is transferred from the conveyance path 702 to other conveyance paths, such as the conveyance paths 704 and 706. This configuration may provide for better spatial optimization by allowing “packing” of different conveyance structures.

Although FIG. 7 depicts three conveyance paths, there may be any number of conveyance paths. Further, the rotation mechanism 710 may rotate one or more conveyance paths. Although the conveyance path 706 is depicted as overlapping the conveyance path 704 in FIG. 7, those skilled in the art will appreciate that any number of conveyance paths may overlap. In one example, three conveyance paths may overlap each other.

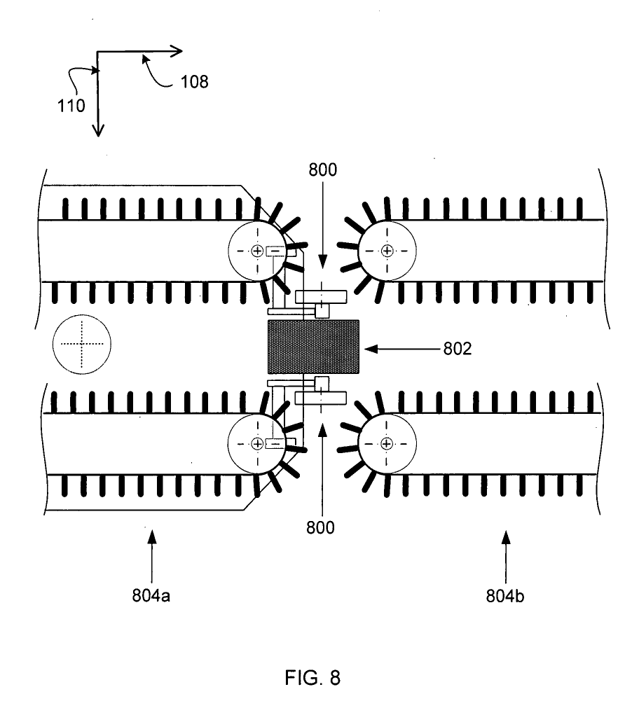

FIG. 8 shows an exemplary embodiment that incorporates an air bearing 802 between a pair of transition mechanisms 800. Exemplary air bearing 802 includes a plurality of small jets, which direct air in vertical direction 106. Pressurized air is provided by an air source (not shown). These air jets provide support for an article (e.g., the article 104) as the article passes over the air bearing 802 during transition from being conveyed by a conveyance path 804a to being conveyed by a conveyance path 804b. In some embodiments, the jets may be actuated only when the article is passing over the air bearing 802. Air bearings can be advantageous when a non-contact support is required.

Some conveyance paths may be “wide” relative to the ability of the article to support itself by its “edges.” For example, substrates for the fabrication of flat panel displays, photovoltaic cells, plywood, and drywall may require substantially uniform support beneath the article. In such situations, it can be advantageous to incorporate one or more air bearings 802 into conveyance paths transporting the articles. In such applications, it may also be advantageous to incorporate one or more air bearings 802 between a pair of transition mechanisms 800 providing support for the article as the article is transferred. The air bearing 802 can be incorporated in such a way that the air bearing 802 moves in concert with the transition mechanisms 800, and in some embodiments, the plane of the air bearing 802 may remain coplanar with rotary components (e.g., wheels) of both transition mechanisms 800. Thus, if the two transition mechanisms 800 operate in a way to provide a tilt about an axis along the direction 108, the air bearing 802 may be tilted to remain coplanar with the transition mechanisms 800.

In some embodiments, a variety of fluid bearings (not shown), in addition to or in place of the air bearing 802, may be incorporated with transition mechanisms (e.g., transition mechanisms 800) and/or conveyance paths (e.g., conveyance paths 804), which may provide for uniform, low friction support of the article. Fluid bearings can be particularly useful for rather wide, flexible, fragile articles or other articles requiring uniform support.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A system for conveying an article, the system comprising:
a first conveyance path with a first end and a second end, the first conveyance path including
a plurality of conveyance rollers arranged to convey the article from the first end to the second end, at least one of the conveyance rollers configured to rotate at a first rate to cause conveyance of the article; and
a transition mechanism disposed proximate to the second end of the first conveyance path and including a transition wheel positioned to receive the article from the second end, the transition wheel configured to be driven at a second rate that is coordinated with the first rate.

2. The system of claim 1, wherein the transition wheel is driven by the first conveyance path via a clutch.

3. The system of claim 2, wherein the clutch comprises a magnetic coupling.

4. The system of claim 1, further comprising a belt disposed around two or more conveyance rollers, the belt configured to transfer a weight of the article to the conveyance rollers.

5. The system of claim 4, further comprising a plurality of protrusions extending from the belt, the protrusions configured to transfer the weight of the article to the belt.

6. The system of claim 1, further comprising a second conveyance path, oriented such that the article can be transferred by the transition mechanism from the first conveyance path to the second conveyance path.

7. The system of claim 6, further comprising a third conveyance path, wherein the transition mechanism can operate to move the article from the first conveyance path to either of the second and the third conveyance paths.

8. The system of claim 1, wherein the first conveyance path includes a rotation mechanism, capable of rotating the first conveyance path and the transition mechanism about a vertical axis.

9. The system of claim 1, wherein the transition mechanism can rotate about an axis parallel to a conveyance direction.

10. The system of claim 1, wherein the position of the transition wheel is adjustable with respect to the second end.

11. The system of claim 1, wherein the transition mechanism includes an air bearing capable of at least partially supporting the article.

12. A system for conveying an article, the system comprising:
a first conveyance path with a first end and a second end, the first conveyance path including
a means to convey the article from the first end to the second end at a first velocity; and
a means to transition the article from the second end of the first conveyance path at a second velocity that is coordinated with the first velocity, the means to transition the article disposed proximate to the second end of the first conveyance path and configured to transition the article from the first conveyance path to a second conveyance path.

13. The system of claim 1, wherein the means to receive the article is driven by the first conveyance path via a clutch.

14. The system of claim 13, wherein the clutch comprises a magnetic coupling.

15. The system of claim 12, wherein the means to convey the article comprises a plurality of protrusions, the protrusions configured to transfer the weight of the article.

16. The system of claim 12, further comprising a third conveyance path, wherein the means to transition the article can operate to move the article from the first conveyance path to either of the second and the third conveyance paths.

17. The system of claim 12, wherein the first conveyance path includes a rotation mechanism, capable of rotating the first conveyance path and the transition mechanism about a vertical axis.

18. The system of claim 12, wherein the means to transition the article can rotate about an axis parallel to a conveyance direction.

19. The system of claim 12, wherein the position of the means to transition the article is adjustable with respect to the second end.

20. The system of claim 12, wherein the means to transition the article includes an air bearing capable of at least partially supporting the article.

21. A method of transferring an article from a first conveyance path to a second conveyance path comprising:
conveying an article to an end of a first conveyance path using a roller of the first conveyance path, the roller rotating at a first rate;
receiving the article from the end of the first conveyance path;
supporting the article using a wheel rotating at a second rate that is coordinated with the first rate; and,
providing the article to a second conveyance path.

22. The method of claim 21, wherein the roller rotating at the first rate includes a vertical roller.

23. The method of claim 21, wherein the article includes a FOUP.

24. The method of claim 21, further comprising changing an elevation of the article using the wheel rotating at the second rate.
